(19) United States
(12) Patent Application Publication
(10) Pub. No.: US 2024/0314621 A1
(43) Pub. Date: Sep. 19, 2024

(54) LATENCY REDUCTION USING PREEMPTION WITHIN A PPDU

(71) Applicant: Apple Inc., Cupertino, CA (US)

(72) Inventors: Wook Bong LEE, San Jose, CA (US); Anuj BATRA, Redwood City, CA (US); Zhou LAN, San Jose, CA (US); Mohamed ABOUELSEOUD, Burlingame, CA (US); Chitlo CHOSH, Fremont, CA (US)

(73) Assignee: Apple Inc., Cupertino, CA (US)

(21) Appl. No.: 18/606,226

(22) Filed: Mar. 15, 2024

Related U.S. Application Data
(60) Provisional application No. 63/452,350, filed on Mar. 15, 2023.

(51) Int. Cl. H04W 28/02; H04W 72/1268; H04W 72/566; H04W 84/12

(52) U.S. Cl. CPC H04W 28/0236; H04W 72/1268; H04W 72/569; H04W 84/12

(57) ABSTRACT

Disclosed herein are apparatuses and a method for implementing latency reduction using preemption within a physical layer (PHY) protocol data unit (PDU) (PPDU). An embodiment operates by encoding a multi-user PPDU (MU-PPDU) for transmission, where, the MU-PPDU comprises a plurality of aggregated media access control (MAC) PDUs (A-MPDUs) addressed to respective non-low-latency stations (non-LL-STAs). Based on a determination that low-latency data addressed to a low-latency station (LL-STA) is available for transmission at a MAC layer of the AP, the embodiment then transmits a preemption-indicator signal to the LL-STA and at least one non-LL-STA. Further, the embodiment identifies an A-MPDU of the plurality of A-MPDUs that is scheduled for transmission over a resource unit (RU) designated for transmitting low-latency data. The embodiment then replaces at least one non-low-latency MPDUs (non-LL-MPDUs) associated with the A-MPDU with at least one low-latency MPDUs (LL-MPDUs) addressed to the LL-STA to generate an updated A-MPDU., where a first LL-MPDU of the plurality of LL-MPDUs is a multi-user block acknowledgment request (MU-BAR) frame associated with the LL-MPDUs. Finally, the embodiment transmits the updated A-MPDU consisting the at least one LL-MPDUs over the RU.

### CROSS REFERENCES

This application claims the benefit of U.S. Provisional Application No. 63/452,350 filed Mar. 15, 2023, titled “LATENCY REDUCTION USING PREEMPTION WITHIN A PPDU,” the content of which is herein incorporated by reference in its entirety.

### BACKGROUND

### Field

The described aspects generally relate to mechanisms for reducing downlink latency in a wireless communication system.

### Related Art

As IEEE 802.11 standards-based applications evolve, their demand for higher data rates, higher reliability, and lower latency also continues to increase. Newer Wi-Fi standards, such as IEEE 802.11be (Wi-Fi 7), provide a multifold increase in throughput compared to prior generations, such as IEEE 802.11ax (Wi-Fi 6). One of the design goals of next-generation Wi-Fi standards (such as Wi-Fi 8) will be to provide ultra-high reliability with ultra-low latencies.

### SUMMARY

Some aspects of this disclosure relate to apparatuses and methods for latency reduction using preemption within a physical layer (PHY) protocol data unit (PPDU). For example, some aspects of this disclosure relate to configuring an access point (AP) to implement a preemptive transmission of low-latency data by replacing one or more non-low-latency MPDUs within an A-MPDU of a multi-user PPDU (MU-PPDU) with one or more low-latency MPDUs.

Some aspects of this disclosure relate to an AP that has a transceiver configured to enable wireless communication, and a processor communicatively coupled to the transceiver. The processor is configured to encode for transmission an MU-PPDU that includes a plurality of aggregated media access control (MAC) PDUs (A-MPDUs) addressed to one or more non-low-latency stations (non-LL STAs). Based on a determination that low-latency data addressed to a low-latency station (LL-STA) is available for transmission at a MAC layer of the AP, the AP transmits a preemption-indicator signal to the LL-STA(s) and at least one non-LL STA. The AP then identifies an A-MPDU that is scheduled for transmission over a resource unit (RU) designated for transmitting low-latency data and replaces one or more non-low-latency MPDUs (non-LL-MPDUs) associated with the A-MPDU with one or more low-latency MPDUs (LL-MPDUs) addressed to the LL-STA(s) to generate an updated A-MPDU. A first LL-MPDU of the one or more LL-MPDUs can be a multi-user block acknowledgment request (MU-BAR) frame associated with the one or more LL-MPDUs. The AP then transmits, using the transceiver, the updated A-MPDU that includes the one or more LL-MPDUs over the RU. The updated A-MPDU is transmitted at a time subsequent to transmission of the preemption-indicator signal.

According to some aspects, the processor is further configured to transmit, using the transceiver, the preemption-indicator signal periodically during predetermined time intervals. According to some aspects, the MU-PPDU further includes a PHY preamble, and the processor is further configured to encode information corresponding to a location of the RU in a field of the PHY preamble. According to some aspects, the field of the PHY preamble can be a signal field (SIG).

According to some aspects, the processor is further configured to transmit, using the transceiver, a long training field (LTF) signal over a first subset of tones within the RU. Alternatively, based on a determination that low-latency data is not available at the MAC layer of the AP, the processor is further configured to transmit, using the transceiver, an orthogonal sequence of an LTF signal over a first subset of tones within the RU during a predetermined time interval, according to some aspects. Alternatively, to indicate preemptive transmission of low latency data, the processor can transmit at least a portion of a predetermined sequence, e.g., as part of the preemption-indicator signal. Alternatively, to indicate an absence of a preemptive transmission, the processor can transmit at least a portion of a sequence that is orthogonal to the predetermined sequence, e.g., as part of the preemption-indicator signal, or some other predetermined sequence can be transmitted to indicate the absence of a preemptive transmission.

According to some aspects, the processor is further configured to transmit, using the transceiver, a portion of a station identifier (STA-ID) corresponding to the LL-STA over a second subset of tones within the RU. According to some aspects, the preemption-indicator signal is transmitted over an entire bandwidth corresponding to the MU-PPDU. Furthermore, one or more A-MPDUs of the plurality of A-MPDUs can begin with an MU-BAR trigger frame addressed to a respective non-LL-STA. According to some aspects, the processor is further configured to allocate a second RU to receive an uplink block acknowledgment (BA) from the LL-STA.

Some aspects of this disclosure relate to a low-latency station (LL-STA) that has a transceiver configured to enable wireless communication, and a processor communicatively coupled to the transceiver. The processor is configured to receive, using the transceiver, a preemption-indication signal transmitted by the AP. The LL-STA then determines, based on the received preemption-indication signal, whether any low-latency data transmission is addressed to the LL-STA. Based on a determination that low-latency data transmission is addressed to the LL-STA, the LL-STA transitions to a full-capability-receiver mode. In the full-capability-receive mode, the LL-STA receives and decodes one or more low-latency media access control (MAC) protocol data units (PDUs) (LL-MPDUs), where the one or more LL-MPDUs are received over a RU designated for receiving the low-latency data transmission.

According to some aspects, the one or more LL-MPDUs are received within an aggregated MPDU (A-MPDU) that is generated by replacing one or more non-low-latency MPDUs (non-LL-MPDUs) within the A-MPDU with the one or more LL-MPDUs. Furthermore, the first LL-MPDU of the one or more LL-MPDUs can be a multi-user block acknowledgment request (MU-BAR) frame associated with the one or more LL-MPDUs.

According to some aspects, to receive the preemption-indication signal, the processor is further configured to receive, using the transceiver, a PHY preamble of an MU-PPDU transmitted by the AP, where the MU-PPDU carries an A-MPDU that includes the one or more LL-MPDUs. A location of the RU is determined by decoding a field in the PHY preamble, such as a signal field (SIG).

According to some aspects, to receive the preemption-indication signal, the processor is further configured to receive, using the transceiver, a PHY preamble of an MU-PPDU transmitted by the AP. A location of the preemption-indication signal can be determined by decoding a field of the PHY preamble.

According to some aspects, to determine that the AP indicated low-latency data transmission is addressed to the LL-STA, the processor is further configured to receive, using the transceiver, a long training field (LTF) signal over a first subset of tones within the RU. Furthermore, at least a portion of a station identifier (STA-ID) corresponding to the LL-STA is received over a second subset of tones within the RU. According to some aspects, based on a determination that the AP did not indicate a low-latency transmission addressed to the LL-STA, the processor is further configured to enter, or remain in, a limited-capability-receiver mode and maintain timing synchronization. Furthermore, to determine that the AP did not indicate low-latency data transmission addressed to the LL-STA, the processor is further configured to receive, using the transceiver, an orthogonal sequence of an LTF signal over a first subset of tones within the RU during a predetermined time interval.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example wireless local area network (WLAN) system 100 implementing latency reduction using preemption within a multi-user (MU) physical layer (PHY) protocol data unit (PDU) (MU-PPDU), according to some aspects of the disclosure.

FIG. 2 illustrates a block diagram of an example system of an electronic device implementing latency reduction using preemption within a PPDU, according to some aspects of the disclosure.

FIG. 3 illustrates the format of an example MU-PPDU transmitted over the downlink with preemptive low-latency data, according to some aspects of this disclosure.

FIG. 4 illustrates an example method performed by an access point (AP) for implementing latency reduction using preemption within a PPDU, according to some aspects of this disclosure.

FIG. 5 illustrates an example method performed by a low-latency station implementing latency reduction using preemption within a PPDU, according to some aspects of this disclosure.

FIG. 6 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Wireless local area network (WLAN) technologies based on the IEEE 802.11 family of standards have steadily seen a significant increase in achievable data rates. Devices based on the latest generation of Wi-Fi technology, Wi-Fi 7, can support data rates in the range of 40 gigabits per second. The usage of Wi-Fi technologies continues to expand and find new applications demanding additional capacity. Emerging use cases like metaverse, augmented reality (AR), and virtual reality (VR) are characterized by high throughput requirements combined with stringent latency and reliability requirements.

The focus areas for the next generation ultra-high reliability (UHR) WLAN (e.g., Wi-Fi 8) include increased reliability of WLAN connectivity, lower latencies and deterministic latency support, increased manageability and mobility support, increased performance in congested environments, further throughput enhancements over Wi-Fi 7, and reduced device-level power consumption. However, low latency applications are challenging to implement in wireless networks that communicate over a shared medium. More specifically, the non-deterministic nature of the IEEE 802.11 medium access control (MAC) layer in the unlicensed spectrum makes it difficult to achieve ultra-low latency. Accordingly, enhanced latency reduction schemes are needed to support the stringent low-latency requirements of the next generation of Wi-Fi applications.

To address the above technological issues, embodiments herein provide enhanced latency reduction schemes for IEEE 802.11-based WLANs. Some aspects of this disclosure relate preemptive transmission of low latency data in the downlink. Additionally, some aspects of this disclosure relate to apparatus and methods for implementing preemption with a downlink multi-user physical layer protocol data unit (MU-PPDU).

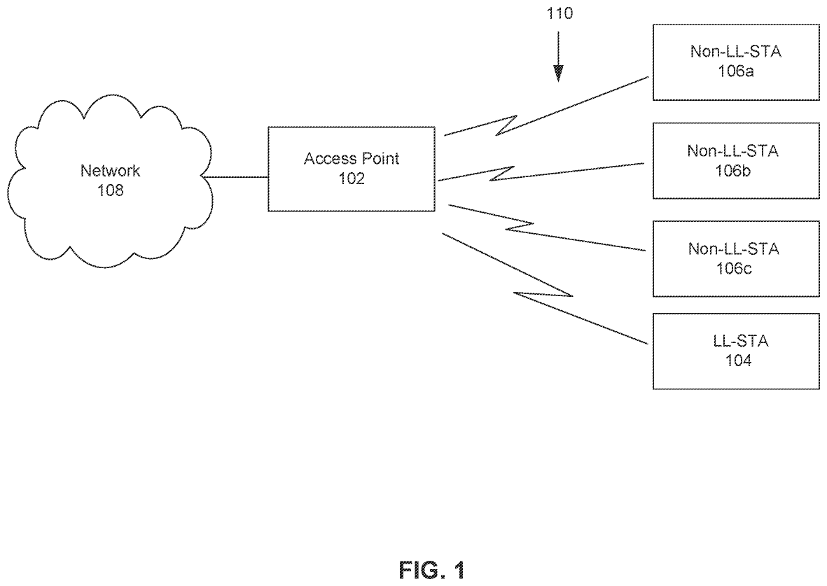

FIG. 1 illustrates an example WLAN system 100 implementing latency reduction using preemption within a multi-user (MU) physical layer (PHY) protocol data unit (PPDU) MU-PPDU, according to some aspects of the disclosure. The example WLAN system 100 is provided for the purpose of illustration only and does not limit the disclosed aspects.

WLAN system 100 can include, but is not limited to, access point (AP) 102, low-latency station (LL-STA) 104, non-low-latency stations (non-LL-STAs) 106a-c, and network 108. According to some aspects, LL-STA 104 implements a low-latency application that requires low-latency communication with AP 102.

According to some aspects, the AP 102 can be an AP multi-link device (MLD) and the STAs 104 and 106 a-c can be non-AP MLDs. Non-LL-STAs 106 a-c and LL-STA 104 can be any type(s) of WiFi capable device, such as a smart phone, a personal digital assistant (PDA), a wireless modem, a wireless communication device, a handheld device, a laptop, a desktop, a cordless phone, a wireless local loop station, a wireless sensor, a tablet, a camera, a video surveillance camera, a gaming device, a netbook, an ultrabook, a medical device or equipment, a biometric sensor or device, a wearable device (smart watch, smart clothing, smart glasses, smart wrist band, smart jewelry such as smart ring or smart bracelet), an entertainment device (e.g., a music or video device, or a satellite radio), a vehicular component, a smart meter, an industrial manufacturing equipment, a global positioning system device, an Internet-of-Things (IoT) device, a machine-type communication (MTC) device, an evolved or enhanced machine-type communication (cMTC) device, or any other suitable device that is configured to communicate via a wireless medium. For example, a MTC and eMTC device can include a robot, a drone, a location tag, and/or the like. Furthermore, any of STAs 104 and 106 a-c can be an augmented reality device, a virtual reality device, a mixed reality device, or the like. Network 108 can be any network, such as the Internet, an enterprise or personal local area network, or a wide area network.

In WLAN system 100, AP 102 and non-LL-STAs 106 a-c and LL-STA 104 operate in accordance with the medium access control (MAC)/PHY specification of IEEE 802.11 family of standards. AP 102 and non-LL-STAs 106 a-c and LL-STA 104 communicate via wireless communication channel 110. AP 102 and non-LL-STAs 106 a-c and LL-STA 104 can communicate using a 20 MHz, 40 MHZ, 80 MHz, or 160 MHz channel. The wireless communications between AP 102 and STAs 104 and 106 a-c can be based on a wide variety of wireless communication techniques. These communication techniques can include, but are not limited to, techniques based on one or more IEEE 802.11 standards such as, but not limited to, IEEE 802.11n, IEEE 802.11ad, IEEE 802.11ac, IEEE 802.11ax, IEEE 802.11bc, IEEE 802.11bd, IEEE 802.11be, IEEE 802.11v, and others known to those skilled in the arts. AP 102 and STAs 104 and 106 a-c can be configured to communicate via channels in the 2.4 GHz, 5 GHZ, 6 GHZ, or 60 GHz ISM bands. Furthermore, AP 102 and non-LL-STAs 106 a-c and LL-STA 104 can communicate using one or more channels with one or more bandwidths, such as 20 MHz, 40 MHz, 80 MHZ, and/or 160 MHZ.

According to some aspects, WLAN system 100 supports downlink multi-user transmission. During DL multi-user transmission, AP 102 can simultaneously transmit DL data to non-LL-STAs 106 a-c and LL-STA 104. According to some aspects, AP 102 can simultaneously transmit data to multiple STAs using MU-MIMO and/or OFDMA techniques. For example, AP 102 generates a MU-PPDU with multiple A-MPDUs, where one or more A-MPDUs of the MU-PPDU are addressed to one or more STAs (e.g., LL-STA 104 and non-LL STAs 106a-c).

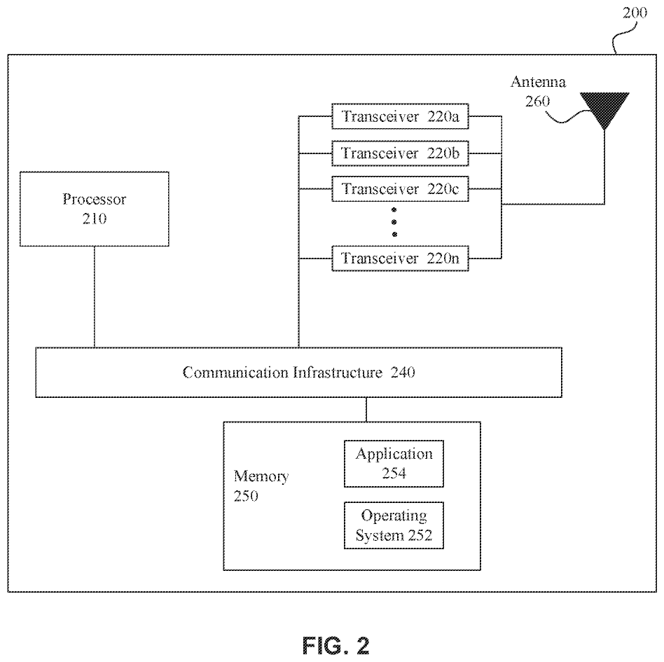

FIG. 2 illustrates a block diagram of an example system 200 of an electronic device implementing latency reduction using preemption within a PPDU, according to some aspects of the disclosure. System 200 can be any of the AP 102, non-LL STAs 106a-c, or LL-STA 104, of WLAN system 100. System 200 includes processor 210, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 can include random access memory (RAM) and/or cache, and can include control logic (e.g., computer software) and/or data. Memory 250 can include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to, radio streaming, video streaming, remote control, and/or other user applications.

System 200 can also include communication infrastructure 240. Communication infrastructure 240 provides communication between, for example, processor 210, one or more transceivers 220a-220n, and memory 250. In some implementations, communication infrastructure 240 can be a bus. Processor 210, together with computer instructions stored in memory 250, performs operations enabling system 200 to implement latency reduction using preemption within a MU-PPDU, according to some aspects of the disclosure, as described herein. Alternatively, processor 210 can be “hard-coded” to implement latency reduction using preemption within a MU-PPDU, as described herein.

One or more transceivers 220a-220n transmit and receive communications signals that support latency reduction based on preemption within a PPDU, according to some aspects, and can be coupled to antenna 260. Antenna 260 can include one or more antennas that can be the same or different types. One or more transceivers 220a-220n enable system 200 to communicate with other devices that can be wired and/or wireless. In some examples, one or more transceivers 220a-220n can include processors, controllers, radios, sockets, plugs, amplifiers, filters, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a cellular subsystem, a WLAN subsystem, and/or a Bluetooth™ subsystem, each including its own radio transceiver and protocol(s) as will be understood by those skilled arts based on the discussion provided herein. In some implementations, one or more transceivers 220a-220n can include more or fewer systems for communicating with other devices.

In some examples, one or more transceivers 220a-220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, one or more transceivers 220a-220n can include one or more circuits (including a cellular transceiver) for connecting to and communicating on 802.11 based WLANs and the like. For example, one or more transceivers 220a-220n can be configured to operate according to one or more IEEE 802.11n, IEEE 802.11ad, IEEE 802.11ac, IEEE 802.11ax, IEEE 802.11bc, IEEE 802.11bd, IEEE 802.11be, IEEE 802.11v, or other of the IEEE 802.11 standards.

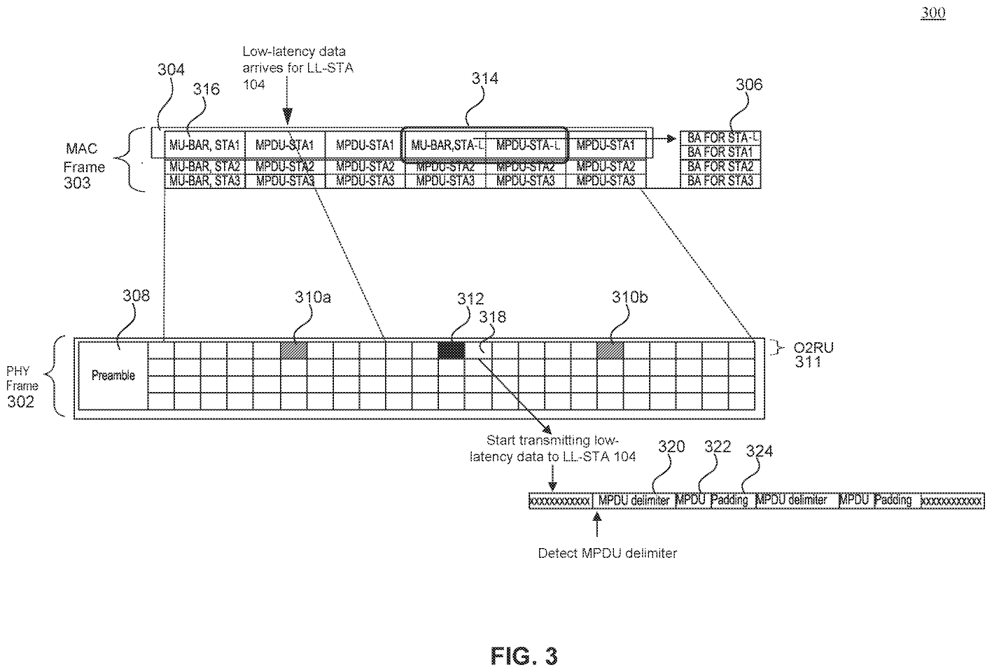

FIG. 3 illustrates the format of an exemplary MU-PPDU 302 transmitted over the downlink, according to some aspects of this disclosure. In the example of FIG. 3, during a downlink multi-user transmission, AP 102 simultaneously transmits data to multiple STAs (e.g., non-LL STAs 106a-c and LL-STA 104). MU-PPDU 302 is the physical layer (PHY) frame transmitted by AP 102 to non-LL STAs 106a-c and LL-STA 104. A MAC frame 303 is encapsulated as payload within MU-PPDU 302 (i.e., the PHY frame). Furthermore, the MAC frame 303 encapsulated within MU-PPDU 302, in turn, can have multiple A-MPDUs (e.g, A-MPDU 304). For example, AP 102 generates an MU-PPDU 302 (e.g., PHY frame) encapsulating multiple A-MPDUs, where A-MPDUs of the MU-PPDU 302 are addressed to one or more non-LL-STA (e.g., non-LL STAs 106a-c). According to some aspects, AP 102 can transmit an MU-PPDU to multiple STAs using MU-MIMO and/or OFDMA techniques.

In the example of FIG. 3, MU-PPDU 302 includes a preamble 308 and the MAC frame 303 as the payload. MU-PPDU 302's payload (e.g., the MAC frame 303) includes three A-MPDUs, each addressed to a different non-LL-STA, as an example. Furthermore, one or more A-MPDUs of the MU-PPDU 302 can include multiple MPDU subframes addressed to one or more non-LL-STAs. For example, each MPDU subframe of the first A-MPDU 304 is addressed to non-LL-STA1 (e.g., non-LL-STA 106a) (with the exception of portion 314 discussed below), each MPDU subframe of the second A-MPDU is addressed to non-LL-STA2 (e.g., non-LL-STA 106b), and each MPDU subframe of the third A-MPDU is addressed to non-LL-STA3 (e.g., non-LL-STA 106c). In other instances, MPDUs and A-MPDUs can be arranged and addressed differently.

According to some aspects, each A-MPDU of the MU-PPDU 302 has a multi-user block acknowledgment request (MU-BAR) as the first subframe. MU-BAR is a trigger frame used by AP 102 to efficiently solicit block acknowledgments from the STAs receiving the multi-user downlink transmissions. In the example of FIG. 3, the first A-MPDU 304 starts with MU-BAR 316 addressed to non-LL-STA1. Upon successfully receiving all transmitted MPDUs of the first A-MPDU 304, non-LL-STA1 can transmit a block acknowledgement (BA) (e.g., BA for STA1). Also, the second A-MPDU starts with an MU-BAR addressed to non-LL-STA2. In response to the receiving the MU-BAR, and upon successfully receiving all transmitted MPDUs of the second A-MPDU, non-LL-STA2 can transmit a BA (e.g., BA for STA2). Furthermore, the third A-MPDU starts with an MU-BAR addressed to non-LL-STA3. In response to receiving the MU-BAR, and upon successfully receiving all transmitted MPDUs of the third A-MPDU, non-LL-STA3 can respond with a BA (e.g., BA for STA3).

According to some aspects, one or more MPDU subframes can include an MPDU delimiter 320 followed by an MPDU 322. Additionally, to adjust and align the lengths of the MPDU subframes, padding 324 can be added, e.g., after the MPDU. The MPDU delimiter 320 can include any/all of a reserved field, an MPDU length field, a cyclic redundancy check (CRC) field, and a delimiter signature field. The MPDU length field includes information regarding a length of the MPDU. The CRC field includes CRC information for checking an error, and the delimiter signature field includes pattern information used for searching for an MPDU delimiter. MPDUs within the MPDU subframe can include a MAC header, a frame body, and/or a frame check sequence (FCS).

According to some aspects, AP 102 transmits all A-MPDUs within the MU-PPDU 302 (e.g., PHY frame) concurrently over different resource units (RUS). An RU includes a group of consecutive subcarriers or tones that can be allocated to different STAs during a multi-user transmission. An RU can be, e.g., a 26-tone RU, a 52-tone RU, a 106-tone-RU, a 242-tone RU, a 484-tone RU, a 996-tone RU, 2×996 tone RU, 3×996 RU, 4×996 RU, or others. (Herein “tone” is synonymous with “subcarrier,” e.g, “frequency subcarrier.”) The 26-tone RU is the smallest RU and occupies approximately 2 MHZ bandwidth. Furthermore, a 20 MHz channel can support up to nine 26-tone RUs, up to four 52-tone RUs, up to two 106-tone RUs, or one 242-tone RU.

According to some aspects, A-MPDUs of the MU-PPDU are configured to be transmitted over different RUs. In the example of FIG. 3, the first A-MPDU 304 is assigned a first RU, the second A-MPDU is assigned a second RU, and the third A-MPDU is assigned a third RU. Each of the first, second, and third RUs can be any of a 26-tone RU, a 52-tone RU, a 106-tone-RU, a 242-tone RU, a 484-tone RU, or a 996-tone RU.

According to some aspects, one of the configured RUs is designated for transmitting low-latency data to LL-STAs. The RU designated for transmitting low-latency data is referred to as an opportunistically overloaded resource unit (O2RU). In the example of FIG. 3, the first RU (e.g., the RU to which A-MPDU 304 is assigned) is designated as the O2RU, which is shown as O2RU 311 in FIG. 3. An O2RU can include multiple RUs (MRUs).

According to some aspects, non-low-latency MPDUs (non-LL-MPDUs) corresponding to one or more non-LL-STAs can be scheduled for transmission over the O2RU 311. In the example of FIG. 3, A-MPDU 304, which is addressed to non-LL-STA1, is scheduled for transmission over the O2RU 311. However, when the MAC layer of AP 102 has low-latency data to send to one or more LL-STAs, LL-MPDUs corresponding to the one or more LL-STAs are preemptively transmitted over the O2RU 311.

According to some aspects, to preemptively transmit low-latency data over the O2RU 311, AP 102 identifies A-MPDU 304, which is configured for transmission over O2RU 311. AP 102 then replaces one or more non-LL-MPDUs of A-MPDU 304 with one or more LL-MPDUs carrying the low-latency data. In the example of FIG. 3, two non-LL-MPDUs addressed to non-LL-STA1 in portion 314 of A-MPDU 304 are replaced by two LL-MPDUs addressed to LL-STA 104. Therefore, when AP 102 has low-latency data to send to LL-STA 104, AP 102 can combine one or more LL-MPDUs (addressed to LL-STA 104) within A-MPDU 304 with one or more non-LL-MPDUs (addressed to non-LL-STA1). Furthermore, of the two LL-MPDUs (e.g., MU-BAR, STA-L and MPDU-STA-L) addressed to LL-STA 104, the first LL-MPDU (e.g., MU-BAR, STA-L) can be an MU-BAR subframe. According to some aspects, in response to successfully receiving the LL-MPDUs, LL-STA 104 responds with a BA (e.g., BA for STA-L 306). To enable LL-STA 104 to transmit the BA, AP 102 can reserve an RU in the uplink. Alternatively, when there is no preemption, the uplink RU allotted for the BA from LL-STA may remain unutilized.

According to some aspects, AP 102 transmits one or more preemption-indicator signals (e.g., 310 a-b and 312) to indicate whether there will be a preemptive transmission of low latency data. In the example of FIG. 3, preemption-indicator signal 312 indicates an upcoming preemptive transmission of low-latency data. In contrast, preemption-indicator signals 310 a-b indicate that there are no upcoming preemptive transmissions of low-latency data, at least until the transmission of the next preemption-indicator signal. Therefore, preemption-indicator signal 310a indicates that there will be no preemptive transmission of low-latency data before the next preemption-indicator signal (e.g., 312). Furthermore, preemption-indicator signals (e.g., 310 a-b and 312) can be transmitted at predefined resource locations in time and frequency. According to some aspects, a preemption-indicator signal (e.g., 310 a-b and 312) can be transmitted at one or more predetermined time intervals. For example, a preemption-indicator signal (e.g., 310 a-b and 312) can be transmitted periodically (e.g., every 1 ms). In the frequency domain, preemption-indicator signals (e.g., 310 a-b and 312) can be transmitted within the O2RU 311. Alternatively, one or more preemption-indicator signals (e.g., 310 a-b and 312) can be transmitted over the entire bandwidth of the MU-PPDU 302.

According to some aspects, to indicate preemptive transmission of low latency data, AP 102 can transmit the whole, or a portion of a, long training field (LTF) sequence as part of the preemption-indicator signal (e.g., 312). Alternatively, to indicate an absence of preemptive transmission, AP 102 can transmit the whole, or a portion of a, sequence that is orthogonal to the long training field (LTF) sequence as part of the preemption-indicator signal (e.g., 310 a-b). According to some aspects, to indicate preemptive transmission of low latency data, AP 102 can transmit the whole, or a portion of a, predetermined sequence as part of the preemption-indicator signal (e.g., 312). Alternatively, to indicate an absence of preemptive transmission, AP 102 can transmit the whole, or a portion of a, sequence that is orthogonal to the predetermined sequence or some other predetermined sequence as part of the preemption-indicator signal (e.g., 310 a-b). According to some aspects, AP 102 transmits preemption-indication signal 312 to indicate an upcoming preemptive transmission. After which, at resource element 318, AP 102 starts transmitting the low-latency portion 314 of A-MPDU 304 over the O2RU 311. One or more MPDU subframes of the low-latency portion 312 can include an MPDU delimiter 320 followed by an MPDU 322. One or more MPDU subframes of the low-latency portion 312 also can include padding 324.

According to some aspects, the preemption-indicator signal (e.g., 310 a-b and 312) transmission occasion can have a duration of one OFDM symbol (e.g., 4 microseconds). Alternatively, the preemption-indicator signal (e.g., 310 a-b and 312) transmission occasion can have a duration of multiple OFDM symbols. According to some aspects, the preemption-indicator signal (e.g., 310 a-b and 312) is transmitted within the O2RU 311 over one or more OFDM symbols.

According to some aspects, a station identifier (STA-ID) corresponding to the intended recipient of the low-latency data (e.g., the STA-ID of the LL-STA 104) can be included as part of the preemption-indicator signal (e.g., 310 a-b and 312). When the preemption-indicator signal (e.g., 310 a-b and 312) is transmitted within the O2RU 311, a subset of the tones of the O2RU 311 can be used to transmit the whole, or a portion of the, preemption-indicator sequence. Furthermore, another subset of the tones of the O2RU 311 can be modulated and encoded to transmit the whole, or a portion of the, STA-ID of the LL-STA 104. For example, the even-numbered tones can be used to transmit the whole, or a portion of the, preemption-indicator sequence and the odd-numbered tones can be used to transmit the whole, or a portion of the, STA-ID. In other examples, the order can be reversed.

According to some aspects, when the O2RU 311 is a 26-tone RU, 13 tones can be used for transmitting the preemption-indicator sequence. The remaining 13 tones can be used to transmit a modulated and/or encoded STA-ID. For example, using a block coding scheme of rate 0.5 and BPSK modulation, up to 7 bits of the STA-ID can be transmitted over the 13 tones of the O2RU 311. According to some aspects, the STA-ID can be 11 bits in length, and up to 7 bits of the 11 bit STA-ID can be sent when a 26-tone O2RU 311 and one OFDM symbol are used for transmitting the preemption-indicator signal.

According to some aspects, when the O2RU 311 is a 52-tone RU, 26 tones can be used for transmitting the preemption-indicator sequence. The remaining 26 tones can be used to transmit a modulated and/or encoded STA-ID. For example, using a convolution code of rate 0.5 and BPSK modulation, up to 7 bits of the STA-ID and 6 tail bits can be transmitted over the 26 tones of the O2RU 311 over one OFDM symbol. According to some aspects, when the O2RU 311 is a 106-tone resource unit, 53 tones can be used for transmitting the preemption-indicator sequence. The remaining 53 tones can be used to transmit a modulated and/or encoded STA-ID. For example, using a convolution code of rate 0.5 and BPSK modulation, 11 bits of the STA-ID, 4 bits of CRC, 5 bits of control bits, and 6 tail bits can be transmitted over the allotted 53 tones of the O2RU 311.

According to some aspects, with a STA-ID of 11 bits, the entire STA-ID can be transmitted when the O2RU 311 has 106-tones. Furthermore, when the O2RU 311 has a size greater than 106 tones, (e.g., 242 tones), two or more STA-IDs corresponding to two or more LL-STAs can be transmitted along with a 4 bit CRC and 6 tail bits. According to some aspects, when a single OFDM symbol is used for transmission the preemption-indicator signal, only a portion of the STA-ID can be transmitted with a 26-tone or a 52-tone O2RU 311. However, by using two OFDM symbols to transmit the preemption-indicator signal, the entire 11-bit STA-ID can be transmitted using a 26-tone or a 52-tone O2RU 311. Alternatively, a smaller size STA-ID (e.g., 6 bit STA-ID) for LL-STAs can be defined. Using the smaller size STA-ID, the entire STA-ID can be transmitted using a 26-tone or a 52-tone O2RU 311 over a single OFDM symbol.

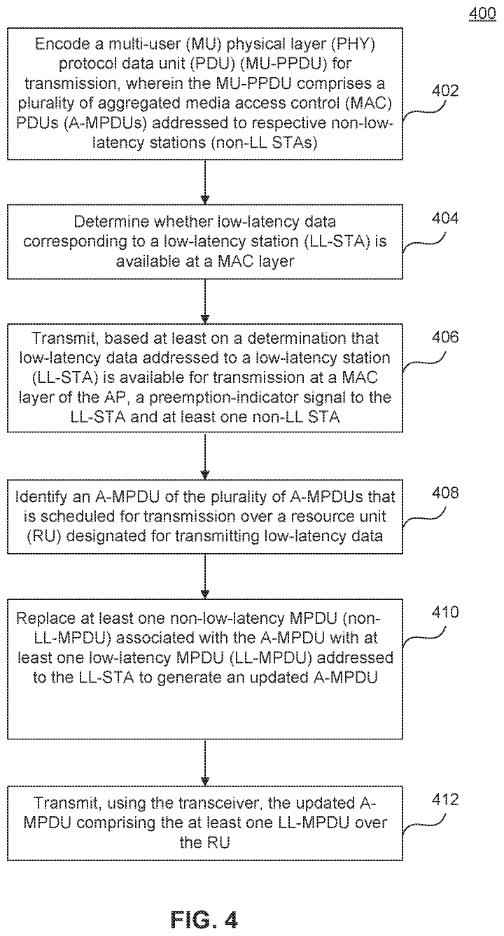

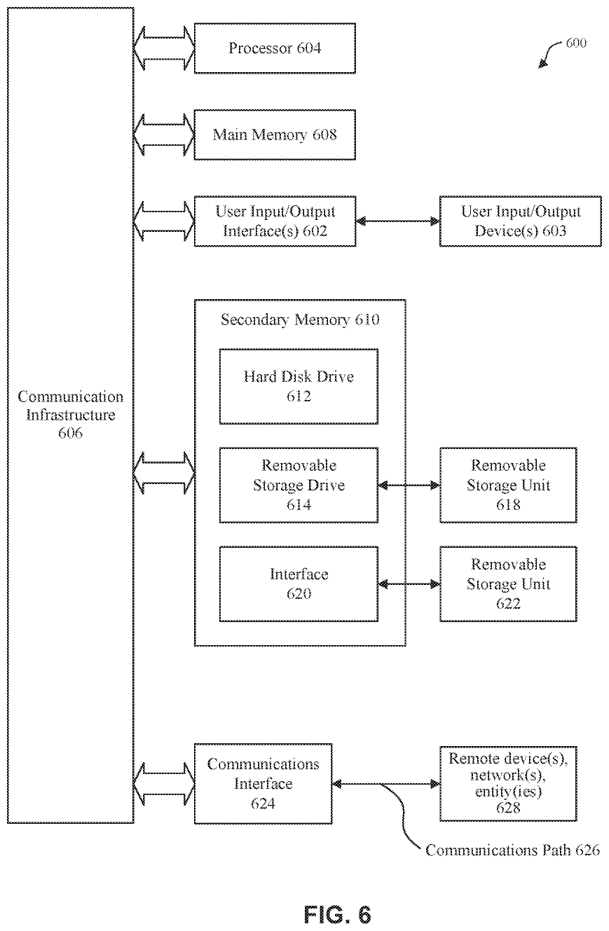

FIG. 4 illustrates an exemplary method 400 performed by AP 102 for implementing latency reduction using preemption within a PPDU, according to some aspects of this disclosure. As a convenience and not a limitation, FIG. 4 can be described with regard to elements of FIGS. 1 and 3, for example, by AP 102. Method 400 can also be performed by system 200 of FIG. 2 and/or computer system 600 of FIG. 6. But method 400 is not limited to the specific aspects depicted in those figures, and other systems can be used to perform the method as will be understood by those skilled in the art. It is to be appreciated that not all operations may be needed, and the operations may not be performed in the same order as shown in FIG. 4.

At 402, AP 102 encodes a multi-user (MU) physical layer (PHY) protocol data unit (PDU) (MU-PPDU) 302 for transmission, where MU-PPDU 302 includes a plurality of aggregated media access control (MAC) PDUs (A-MPDUs) addressed to respective non-LL STAs. For example, A-MPDU 304 is addressed to non-LL-STA1 (e.g., non-LL-STA 106a), the second A-MPDU is addressed to non-LL-STA2 (e.g., non-LL-STA 106b), and the third A-MPDU is addressed to non-LL-STA3 (e.g., non-LL-STA 106c). Furthermore, each MPDU subframe of the first A-MPDU 304 is addressed to non-LL-STA1 with the exception of portion 314, each MPDU subframe of the second A-MPDU is addressed to non-LL-STA2, and each MPDU subframe of the third A-MPDU is addressed to non-LL-STA3.

According to some aspects, each A-MPDU of the MU-PPDU is configured to be transmitted over a different RU. Furthermore, one of the configured RUs is designated for transmitting low-latency data to LL-STA 104. The RU designated for transmitting low-latency data is referred to as an opportunistically overloaded resource unit (O2RU), which is shown as O2RU 311 in FIG. 3. According to some aspects, AP 102 can transmit low-latency data corresponding to one or more LL-STAs over the O2RU 311. According to some aspects, information corresponding to the identity and/or location of the O2RU 311 is encoded in a field of the PHY preamble 308 of the MU-PPDU 302. According to some aspects, preamble fields such as the universal signal (U-SIG) field, the common ETH-SIG field, the user-specific ETH-SIG field, and/or the like, can be used to indicate the information corresponding to the identity and/or location of O2RU 311.

At 404, AP 102 determines whether low-latency data corresponding to a low-latency station (LL-STA) (e.g., LL-STA 104) is available at a MAC layer.

At 406, based on a determination that low-latency data addressed to LL-STA 104 is available for transmission at a MAC layer of AP 102, it transmits a preemption-indicator signal 312 to the LL-STA 104 and at least one non-LL STA (e.g., non-LL-STA 106 a-c). According to some aspects, to indicate preemptive transmission of low latency data, AP 102 can transmit the whole or a portion of a predetermined sequence as part of the preemption-indicator signal 312. According to some aspects, AP 102 transmits the whole or a portion of a predetermined long training field (LTF) signal over a subset of tones within the O2RU 311 to indicate a subsequent preemptive transmission of low-latency data to LL-STA 104. According to some aspects, AP 102 includes an LTF sequence in the preamble 308. A receiving STA (e.g., non-LL STAs 106a-c, and LL-STA 104) can use the LTF signal in the preamble 308 to perform fine synchronization and initial channel estimation. In addition, AP 102 again transmits a copy of the LTF as part of the preemption-indicator signal 312 to indicate preemptive transmission of low-latency data. According to some aspects, AP 102 also transmits the whole or a portion of a station identifier (STA-ID) corresponding to the LL-STA 104 using another subset of tones within the O2RU 311.

Alternatively, based on a determination that low-latency data addressed to LL-STA 104 is not available for transmission at the MAC layer, AP 102 transmits a preemption-indication signal (e.g., 310 a-b). According to some aspects, each preemption-indication signal 310 a-b can include the whole or a portion of a sequence that is orthogonal to a predetermined sequence or some other sequence, and is transmitted over a first subset of tones within O2RU 311. According to some aspects, each preemption signal 310 a-b can include the whole or a portion of a sequence that is orthogonal to the LTF signal, and is transmitted over a subset of tones within O2RU 311.

According to some aspects, AP 102 transmits the preemption-indicator signal periodically during predetermined time-intervals. Furthermore, the preemption-indicator signal is transmitted over one or more OFDM symbols within the O2RU 311. According to some aspects, information corresponding to the location of the O2RU 311 is encoded in a field of the PHY preamble 308 of the MU-PPDU 302. According to some aspects, preamble fields such as the universal signal (U-SIG) field, the common ETH-SIG field, the user-specific ETH-SIG field, and/or the like, can be used to indicate the information corresponding to the location of the preemption-indicator signals.

At 408, AP 102 identifies an A-MPDU of the plurality of A-MPDUs that is scheduled for transmission over the O2RU 311, which is designated for transmitting low-latency data. According to some aspects, AP 102 identifies and selects the first A-MPDU scheduled for transmission over O2RU 311 after transmitting the preemption-indicator signal indicating an upcoming low-latency data transmission.

At 410, AP 102 replaces a plurality of non-low-latency MPDUs (non-LL-MPDUs) within the selected A-MPDU with a plurality of low-latency MPDUs (LL-MPDUs) addressed to the LL-STA 104 to generate an updated A-MPDU. According to some aspects, the first LL-MPDU of the plurality of LL-MPDUs can be a multi-user block acknowledgment request (MU-BAR) frame associated with the LL-MPDUs. For example, referring to FIG. 3, portion 314 of A-MPDU 304 is constructed so that non-LL-MPDUs (e.g., the MPDU-STA1s) for non-LL-STA1 (e.g., non-LL-STA 106a) are replaced with LL-MPDUs (e.g., MPDU-STA-L) for LL-STA 104. Therefore, when AP 102 has low-latency data to send to LL-STA 104, AP 102 multiplexes LL-MPDUs (addressed to LL-STA 104) with non-LL-MPDUs (addressed to non-LL-STA1) within A-MPDU 304.

At 412, AP 102 transmits the updated A-MPDU 304 over the O2RU 311 at a time subsequent to transmission of the preemption-indicator signal. To transmit A-MPDU 304, AP 102 includes A-MPDU 304 within the MU-PPDU 302. AP 102 then transmits all A-MPDUs within the MU-PPDU 302 simultaneously over different RUs. Furthermore, the MU-PPDU 302 is configured such that A-MPDU 304 carrying the low-latency data is transmitted over O2RU 311. For example, as shown in FIG. 3, A-MPDU 304, along with the multiplexed low-latency data portion 314, is transmitted over O2RU 311. According to some aspects, AP 102 starts transmitting the low-latency portion 314 of A-MPDU 304 at resource element 318. Furthermore, each MPDU subframe of the low-latency data portion 314 includes an MPDU delimiter 320 followed by an MPDU 322 and padding 324.

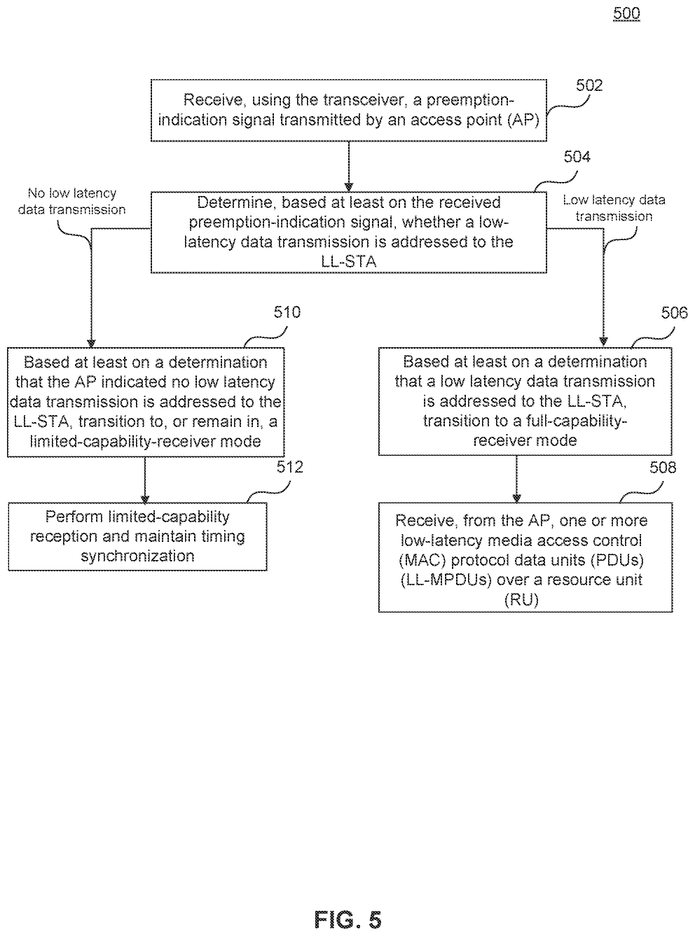

FIG. 5 illustrates an exemplary method 500 performed by a LL-STA implementing latency reduction using preemption within a PPDU, according to some aspects of this disclosure. As a convenience and not a limitation, FIG. 5 can be described with regard to elements of FIGS. 1 and 3, for example by LL-STA 104. Method 500 can also be performed by system 200 of FIG. 2 and/or computer system 600 of FIG. 6. But method 500 is not limited to the specific aspects depicted in those figures, and other systems can be used to perform the method as will be understood by those skilled in the art. It is to be appreciated that not all operations may be needed, and the operations may not be performed in the same order as shown in FIG. 5.

At 502, LL-STA 104 receives a preemption-indication signal (e.g., 310 a-b, or 312) transmitted by AP 102. According to some aspects, information corresponding to the location of the preemption-indication signals 310 a-b and 312 is encoded in a field of the PHY preamble 308 of the MU-PPDU 302. According to some aspects, LL-STA 104 receives the PHY preamble 308 of the MU-PPDU and decodes the information corresponding to the location of the preamble signals 310 a-b and 312.

At 504, LL-STA 104 determines, based on the received preemption-indication signal (e.g., 310 a-b, or 312), whether a subsequent low-latency data transmission is to be sent from the AP 102 and is addressed to the LL-STA. According to some aspects, AP 102 transmits a preemption-indicator signal that includes a predetermined sequence (e.g., an LTF sequence or an orthogonal LTF sequence) and a station identifier (STA-ID) corresponding to the intended recipient of the low-latency data (e.g., LL-STA 104). LL-STA 104 decodes the received sequence and the STA-ID to make a determination whether a subsequent low-latency data transmission is addressed to the LL-STA 104.

At 506, based on a determination that a subsequent low-latency data transmission is addressed to the LL-STA 104, LL-STA 104 transitions to a full-capability-receiver mode, e.g. transitions from a lower power mode to a higher power mode. According to some aspects, when LL-STA 104 receives an LTF sequence and LL-STA 104's STA-ID in the preemption-indicator signal 312, the LL-STA 104 makes a determination that AP 102 will be transmitting low-latency data addressed to it. After which, LL-STA 104 transitions to a full-capability-receiver mode.

At 508, LL-STA 104, operating in the full-capability-receiver mode, receives and decodes a plurality of LL-MPDUs addressed to the LL-STA. For example, portion 314 of A-MPDU 304 includes MPDUs addressed to LL-STA. The plurality of LL-MPDUs are received over the O2RU 311, which is designated for communicating the low-latency data transmission. According to some aspects, information corresponding to the location of the O2RU 311 is obtained by decoding the PHY preamble 308 of the MU-PPDU 302.

At 510, alternatively, based on a determination the AP did not indicate low-latency transmission addressed to the LL-STA 104, LL-STA 104 enters, or remains in, a limited-capability-receiver mode. According to some aspects, when LL-STA 104 receives, in the preemption-indicator signal (310a or 310b), a sequence that is orthogonal to the LTF sequence and/or a STA-ID that does not match LL-STA 104's STA-ID, the LL-STA 104 makes a determination that AP 102 will not be transmitting low-latency data addressed to it. Subsequently, LL-STA 104 transitions to, or remains in, a limited-capability-receiver mode.

At 512, alternatively, LL-STA 104 remains in a limited-capability-receiver mode and maintains timing synchronization. In the limited-capability-receiver mode, it may only perform timing synchronization functions. For example, LL-STA 104 in the limited-capability-receiver mode performs limited functions such as maintaining symbol boundary, code-word boundary, pilot rotation, and/or the like.

Various aspects can be implemented, for example, using one or more computer systems, such as computer system 800 shown in FIG. 8. Computer system 800 can be any well-known computer capable of performing the functions described herein such as AP 102 of FIG. 1. Computer system 800 includes one or more processors (also called central processing units, or CPUs), such as a processor 804. Processor 804 is connected to a communication infrastructure 806 (e.g., a bus). Computer system 800 also includes user input/output device(s) 803, such as monitors, keyboards, pointing devices, etc., that communicate with communication infrastructure 806 through user input/output interface(s) 802. Computer system 800 also includes a main or primary memory 808, such as random access memory (RAM). Main memory 808 can include one or more levels of cache. Main memory 808 has stored therein control logic (e.g., computer software) and/or data.

Computer system 600 can also include one or more secondary storage devices or memory 610. Secondary memory 610 can include, for example, a hard disk drive 612 and/or a removable storage device or drive 614. Removable storage drive 614 can be a floppy disk drive, a magnetic tape drive, a compact disk drive, an optical storage device, tape backup device, and/or any other storage device/drive.

Removable storage drive 614 can interact with a removable storage unit 618. Removable storage unit 618 includes a computer usable or readable storage device having stored thereon computer software (control logic) and/or data. Removable storage unit 618 can be a floppy disk, magnetic tape, compact disk, DVD, optical storage disk, and/any other computer data storage device. Removable storage drive 614 reads from and/or writes to removable storage unit 618 in a well-known manner.

According to some aspects, secondary memory 610 can include other means, instrumentalities or other approaches for allowing computer programs and/or other instructions and/or data to be accessed by computer system 600. Such means, instrumentalities or other approaches can include, for example, a removable storage unit 622 and an interface 620. Examples of the removable storage unit 622 and the interface 620 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 can further include a communication or network interface 624. Communication interface 624 enables computer system 600 to communicate and interact with any combination of remote devices, remote networks, remote entities, etc. (individually and collectively referenced by reference number 628). For example, communication interface 624 can allow computer system 600 to communicate with remote devices 628 over communications path 626, which can be wired and/or wireless, and which can include any combination of LANs, WANs, the Internet, etc. Control logic and/or data can be transmitted to and from computer system 600 via communication path 626.

The operations in the preceding aspects can be implemented in a wide variety of configurations and architectures. Therefore, some or all of the operations in the preceding aspects can be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 600, main memory 608, secondary memory 610 and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 6. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects can perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. An access point (AP), comprising:
a transceiver configured to enable wireless communication; and
a processor communicatively coupled to the transceiver and configured to:
encode a multi-user (MU) physical layer (PHY) protocol data unit (PDU) (MU-PPDU) for transmission, wherein the MU-PPDU comprises a plurality of aggregated media access control (MAC) PDUs (A-MPDUs) addressed to one or more non-low-latency stations (non-LL-STAs);
transmit, based at least on a determination that low-latency data addressed to a low-latency station (LL-STA) is available at a MAC layer of the AP, a preemption-indicator signal to the LL-STA and at least one non-LL-STA;
identify an A-MPDU of the plurality of A-MPDUs that is scheduled for transmission over a resource unit (RU) designated for transmitting low-latency data;
replace at least one non-low-latency MPDU (non-LL-MPDU) associated with the A-MPDU with at least one low-latency MPDU (LL-MPDU) addressed to the LL-STA to generate an updated A-MPDU; and
transmit, using the transceiver, the updated A-MPDU comprising the at least one LL-MPDU over the RU.

2. The AP of claim 1, wherein to transmit the preemption-indicator signal, the processor is further configured to:
transmit, using the transceiver, the preemption-indicator signal periodically.

3. The AP of claim 1, wherein the MU-PPDU further comprises a PHY preamble, and the processor is further configured to:
encode, in a field of the PHY preamble, information corresponding to a location of the RU.

4. The AP of claim 1, wherein to transmit the preemption-indicator signal, the processor is further configured to:
transmit, using the transceiver, a long training field (LTF) signal over a first subset of tones within the RU.

5. The AP of claim 4, wherein to transmit the preemption-indicator signal, the processor is further configured to:
transmit, using the transceiver, a portion of a station identifier (STA-ID) corresponding to the LL-STA over a second subset of tones within the RU.

6. The AP of claim 1, wherein at a second time, based at least on a determination that low-latency data is not available at the MAC layer of the AP, the processor is further configured to:
transmit, using the transceiver, an orthogonal sequence of an LTF signal over a first subset of tones within an RU during a predetermined time-interval.

7. The AP of claim 1, wherein the preemption-indicator signal is transmitted over an entire bandwidth corresponding to the MU-PPDU.

8. The AP of claim 1, wherein at least one A-MPDU of the plurality of A-MPDUs begins with an MU-BAR trigger frame addressed to a respective non-LL-STA.

9. The AP of claim 1, wherein the processor is further configured to:
allocate a second RU to receive an uplink block acknowledgement (BA) from the LL-STA.

10. The AP of claim 1, wherein to transmit the preemption-indicator signal, the processor is further configured to transmit, using the transceiver, a predetermined sequence over a first subset of tones within the RU.

11. The AP of claim 10, wherein at a third time, based at least on a determination that low-latency data is not available at the MAC layer of the AP, the processor is further configured to:
transmit, using the transceiver, a sequence orthogonal to the predetermined sequence over the first subset of tones within the RU.

12. A low-latency station (LL-STA), comprising:
a transceiver configured to enable wireless communication; and
a processor communicatively coupled to the transceiver and configured to:
receive, using the transceiver, a preemption-indication signal transmitted by an access point (AP);
determine, based at least on the received preemption-indication signal, whether a low-latency data transmission is addressed to the LL-STA;
transition, based at least on a determination that a low-latency data transmission is addressed to the LL-STA, to a full-capability-receiver mode; and
receive, from the AP, one or more low-latency media access control (MAC) protocol data units (PDUs) (LL-MPDUs) over a designated resource unit (RU).

13. The LL-STA of claim 12, wherein the one or more LL-MPDUs are received within an aggregated MPDU (A-MPDU).

14. The LL-STA of claim 13, wherein a first LL-MPDU of the one or more LL-MPDUs comprises a multi-user block acknowledgement request (MU-BAR) frame.

15. The LL-STA of claim 12, wherein to receive the preemption-indication signal, the processor is further configured to:
receive, using the transceiver, a PHY preamble of an MU-PPDU transmitted by the AP, wherein the MU-PPDU carries an A-MPDU that comprises the one or more LL-MPDUs; and
determine a location of the RU by decoding a field the PHY preamble.

16. The LL-STA of claim 12, wherein to determine that the AP indicated low-latency data transmission is addressed to the LL-STA, the processor is further configured to:
receive, using the transceiver, a long training field (LTF) signal over a first subset of tones within the RU; and
receive, using the transceiver, at least a portion of a station identifier (STA-ID) corresponding to the LL-STA over a second subset of tones within the RU.

17. The LL-STA of claim 12, wherein at a second time, based at least on a determination the AP did not indicate low-latency transmission addressed to the LL-STA, the processor is further configured to:
enter, or remain in, a limited-capability-receiver mode and maintain timing synchronization.

18. The LL-STA of claim 17, wherein to determine that the AP did not indicate low-latency transmission addressed to the LL-STA, the processor is further configured to:
receive, using the transceiver, an orthogonal sequence of a LTF signal over a first subset of tones within the RU during a predetermined time-interval.

19. A method of operating an access point (AP), comprising:
encoding a multi-user (MU) physical layer (PHY) protocol data unit (PDU) (MU-PPDU) for transmission, wherein the MU-PPDU comprises a plurality of aggregated media access control (MAC) PDUs (A-MPDUs) addressed to one or more non-low-latency stations (non-LL STAs);
transmitting, based on a determination that low-latency data addressed to a low-latency station (LL-STA) is available at a MAC layer of the AP, a preemption-indicator signal to the LL-STA and at least one non-LL STA;
identifying an A-MPDU of the plurality of A-MPDUs that is scheduled for transmission over a resource unit (RU) designated for transmitting low-latency data;
replacing at least one non-low-latency MPDU (non-LL-MPDU) within the A-MPDU with at least one low-latency MPDU (LL-MPDU) addressed to the LL-STA to generate an updated A-MPDU; and
transmitting, using the transceiver, the updated A-MPDU over the RU.

20. The method of claim 19, further comprising:
transmitting, using the transceiver, the preemption-indicator signal periodically.
